(19) United States
(12) Patent Application Publication
(10) Pub. No.: US 2026/0334391 A1
(43) Pub. Date: Oct. 29, 2026

(54) DRIVABLE DRIP STAKE

(71) Applicant: Kody J. KETTERLING, Twin Falls, ID (US)

(72) Inventor: Kody J. KETTERLING, Twin Falls, ID (US)

(21) Appl. No.: 19/189,194

(22) Filed: Apr. 24, 2025

(51) Int. Cl. A01G 25/06

(52) U.S. Cl. CPC A01G 25/06

(57) ABSTRACT

A drivable drip stake serves as an emitter for drip irrigation. The drip stake encloses an open-ended channel between an upper portion and a lower portion. A pair of solid fins and a pair of aerated fins extend the length of the lower portion. The aerated fins define, in fluid communication with the open-ended channel, a plurality of apertures of decreasing diameter that are spaced lengthwise. The proximal end of the upper portion forms a strengthened impactable head for driving the stake into soil, and an enclosed volume within the upper portion houses water soluble fertilizer to enable direct fertilization of plant roots.

### BACKGROUND OF THE INVENTION

### Field of the Invention

The present invention relates generally to irrigation emitters, and more particularly to a drip emitter for a drip irrigation system.

### Description of Related Art

Drip irrigation systems are well known in the art as an alternative to conventional pop-up or rotary style sprinkling systems. Drip irrigation provides better precision and efficiency for water distribution in environments such as gardens and partially planted landscapes by targeting the water supply directly to the vegetation being watered. Drip irrigation releases water under a relatively low pressure and flow rate through drip emitters located on the ground in close proximity to the targeted vegetation. Drip emitters are typically connected to an irrigation line under control of solenoid valves by flexible hoses that can be easily routed around a garden above ground.

Known drip emitters have several different forms. For example, some drip emitters are rigid perforated terminals connected to the flexible feeder line, for example, by barbed hose connections, while others are simply regularly spaced holes formed directly in feeder line, which is also known as trickle hose. Other emitter types can be designed as rigid screws or stakes that can be driven deep into the soil using tools such as hammers and drills. These emitters deliver water deeper into the soil, encouraging plant roots to grow down into the soil, promoting stronger and healthier growth.

Many problems can occur when using these known emitter types. They can be difficult to sink into ground, especially into hardened soil. Once sunk, they can be susceptible to upward leakage of water, particularly when deployed in loose soil environments commonly found in gardens and landscaping. Drip screws are limited to installation in soft, pliable soil, may be unsuitable for use in dry soil or hardened clay where they tend to fracture easily. Further, when deploying these emitter types, and particularly with drip stakes, a user is left with no indication of the direction of the outflow once the emitter has been fully driven to a desired depth.

What is needed is an improved drip emitter that resolves the above mentioned problems.

### SUMMARY OF THE INVENTION

A drip emitter according to the present invention may be designed as a drip stake that can be driven into soil by manual action. The drip stake is preferably formed from durable materials, such as various polymer materials, using a conventional injection molding technique. The drip stake may be molded as a unitary device having all features molded together. The drip stake according to the present invention allows for a targeted delivery of water to a desired depth while preventing pooling of water at the soil surface.

Preferably, the drip stake is designed to be driven into the soil environment. The drivable drip stake includes a stake having an upper portion, a lower portion and an open-ended channel extending longitudinally therethrough. The open-ended channel defines an inlet through a proximal end of the upper portion and a terminal outlet through the distal end of the lower portion. A pair of opposing solid fins may extend from the outer surface of the lower portion. A pair of opposing aerated fins may be positioned between the solid fins and are formed on the outer surface of the lower portion. Each of the aerated fins includes a plurality of holes defined therein, the holes fluidically connecting the open-ended channel with the surrounding soil environment. The proximal end of the upper portion also includes a means for driving the stake into the soil environment. In some preferred embodiments, the driving means includes a planar surface integrally connected to a plurality of trusses extending from the outer surface of the upper portion.

The plurality of holes are preferably arranged so that the hole diameter decreases in the downstream direction. Every upstream hole therefore has a diameter that is greater than or equal to any downstream hole. The holes preferably extend along the longitudinal length of each of the aerated fins. In some embodiments, the plurality of holes may be arranged into groupings based on hole diameter. In such cases, the first grouping having the largest diameter is formed upstream nearest the proximal end of the lower portion, the second grouping having the second largest diameter is formed below the first grouping at an intermediate position along the length of the aerated fins, and the third grouping having the smallest diameter is formed nearest the distal end of the lower portion. In some embodiments, an optional plug may be inserted into the terminal outlet of the open-ended channel to block the outlet. The plug when so installed directs water to exit the drip stake through the plurality of holes.

In some preferred embodiments, the upper portion is designed to create a seal with the soil surrounding the drip stake upon being driven into the ground. The seal formed by the upper portion impacting soil preferably prevents or otherwise diminishes the up-flow of water discharged by the plurality of apertures that extend below the seal. The upper portion may have a smooth outer surface having an outer diameter greater than the outer diameter of the lower portion. The difference in outer diameters aids the upper portion in forming the seal with the surrounding soil.

In some embodiments, the upper portion may also be designed to enclose a fertilizer stick therein while maintaining fluid communication in the channel between the upper portion and the lower portion. The internal diameter of the channel through the upper portion is preferably greater than the internal diameter through the lower portion. The upper portion may include a rim formed about a distal end thereof. The rim is designed as a seat for holding the fertilizer stick within the upper portion while maintaining the necessary fluidic linkage between the upper and lower portions through the channel. The fertilizer stick can be a conventional fertilizer stick made from various substrates that will readily dissolve in water.

These and other features of the present invention will become apparent to the skilled artisan in view of the following detailed disclosure.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a perspective view of an embodiment of a drivable drip stake according to the present invention.

FIG. 2 is a first side view of an embodiment of the drivable drip stake according to the present invention.

FIG. 3 is a second side view, rotated substantially 90-degrees from the view of FIG. 2, of an embodiment of the drivable drip stake.

FIG. 4 is a cross-sectional side view, taken along lines A-A marked in FIG. 3, of the drivable drip stake.

FIG. 5 is a proximal end view of an embodiment of a drivable drip stake according to the present invention.

### DETAILED DESCRIPTION OF THE INVENTION

The following disclosure presents exemplary embodiments for a drip emitter deployable in a drip irrigation system. The drivable drip emitter or drip stake includes a cylindrical stake body with two or more fins extending therefrom for assisting in the drivability of the drip emitter into the soil environment. The proximal end of the drivable drip emitter, or drivable drip stake as it may be referred to hereinafter, is formed with a means for driving the drip stake into the soil environment, the driving means adding sufficient structural integrity to the drip stake to permit an operator to use a rubber mallet or conventional hammer to drive the stake into the ground without causing damage.

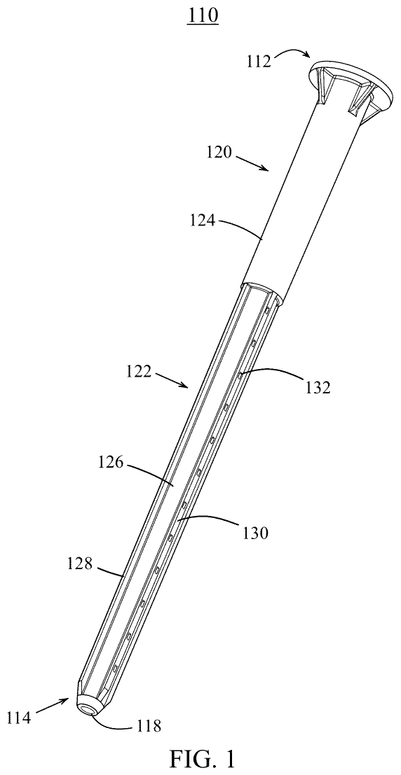

FIG. 1 is a perspective view of one embodiment of a drivable drip stake according to the present invention. The drivable drip stake 110 has a proximal or driving end 112 and a distal or outlet end 114. An open-ended channel 116 extends fully through the drivable drip stake 110 from the proximal end 112 through the distal end 114. An outlet 118 is formed at the distal end 114. The outlet 118 fluidically connects the open-ended channel 116 with the soil environment surrounding the distal end 114.

The drivable drip stake 110 includes an upper portion 120 integrally connected to a lower portion 122. In some embodiments, the upper portion 120 has a smooth outer surface 124. The upper portion 120 is preferably substantially cylindrical. The lower portion 122 is formed by a stake body 126 extending from the upper portion 120. The lower portion 122 includes at least one pair of opposing solid fins 128 (hereinafter referred to as the solid fins 128 or fins 128) extending radially outward from the stake body 126. The solid fins 128 are preferably arranged on opposites sides of the stake body 126 so that each one of the solid fins is separated by 180 degrees from the other solid fin. The solid fins 128 are solid, with no apertures or outlets formed therein. In preferred embodiments, the stake body 126 includes a second pair of opposing fins 130 extending radially outward therefrom. The second pair of fins 130 includes a plurality of outlets or holes 132 defined along the longitudinal length of each fin. The second pair of fins 130 are therefore referred to as the aerated fins 130. The aerated fins 130 are similarly arranged to be on opposite sides of the stake body 126, separated by 180 degrees. The lower portion thus includes one fin, either a solid fin 128 or an aerated fin 130, arranged every 90-degrees around the outer surface of the stake body 126, e.g., solid fin-aerated fin-solid fin-aerated fin. The outlets 132 fluidically connect the open-ended channel 116 extending through the lower portion 122 with the surrounding soil environment.

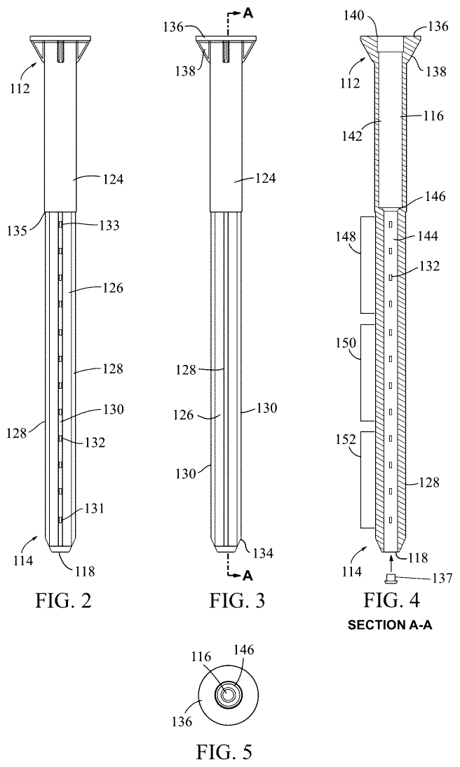

FIG. 2 is a first side view of an embodiment of the drivable drip stake according to the present invention. FIG. 3 is a second side view, rotated 90-degrees from FIG. 2, of an embodiment of the same drivable drip stake. As can be seen in FIG. 2, the solid fins 128 are arranged on opposite sides of the stake body 126. Similarly, as shown by FIG. 3, the aerated fins 130 are also arranged on opposite sides of the stake body 126. Each of the solid fins 128 and the aerated fins 130 extend substantially the full longitudinal length of the lower portion 122 of the drivable drip stake 110. The terminal or distal end 134 of each of the solid fins 128 and the aerated fins 130 tapers into the distal end 114 of the drivable drip stake 110. In preferred embodiments, the terminal end 134 is tapered at a 24-degree angle, although other degrees of taper may be utilized within the scope of the present invention. The tapered terminal end 134 of each of the solid fins 128 and the aerated fins 130 aid in the drivability of the drivable drip stake 110 into a soil environment.

The proximal end 112 of the drivable drip stake 110 is engineered with a means for driving the stake into a soil environment. In preferred embodiments, the driving means is formed as an impactable head, that is, a strengthened surface that can withstand impact from a hammer or other tool striking downward against the head with sufficient force to drive the stake firmly into a desired depth of soil. In one embodiment, the impactable head includes a planar surface 136 arranged perpendicular to the flow direction through the drip stake 110. A plurality of support trusses 138 may extend from the bottom side of the planar surface 136 and are integrally connected to the outer surface 124 of the upper portion 120. In preferred embodiments, the trusses 138 are arranged radially symmetrically around the proximal end 112. For example, there may be four trusses 138 arranged every 90-degrees around the proximal end 112. Alternatively, there may be more or less than four trusses 138 arranged symmetrically around the proximal end 112.

The planar surface 136 provides a user with flat surface for hammering or otherwise driving the drip stake 110 into a soil environment. The trusses 138 add sufficient structural support to the proximal end 112 to prevent the planar surface 136 from breaking or otherwise becoming damaged while the stake 110 is being driven into the ground. A user may drive the drivable drip stake 110 fully into the ground so that only the planar surface 136 remains visible. The outer surface 124 of the upper portion 120 is solid without any apertures or outlets formed therethrough. The upper portion 120 therefore provides an underground buffer of several inches between the top level of the soil and the first outlet, e.g., the outlet labeled 133 in FIG. 2, which reduces the likelihood of water accumulating at the soil surface.

The stake body 126 has an outer diameter, excluding the fins 128 and 130, that is less than the outer diameter of the upper portion 120. A transition point 135, defined as where the upper portion 120 transitions into the lower portion 122, forms a seal by impacting soil driven beneath this point, thereby preventing unwanted up-flow of water discharged by any of the outlets 132. The smaller diameter of the stake body 126 throughout the lower portion 122 allows for soil to be packed tightly at the transition point 135, which reduces or eliminates unwanted up-flow of water when deployed in the ground beyond the transition point 135.

FIG. 4 is cross-sectional side view, taken along lines A-A marked in FIG. 3, of an embodiment of the drivable drip stake according to the present invention. The open-ended channel 116 is visible in this view. The channel 116 extends through the entire length of the drivable drip stake 110, from the proximal end 112 through the distal end 114. The proximal end 112 includes an inlet 140 defined through the center of the planar surface 136 and opening into the channel 116. In preferred embodiments, the inlet 140 is configured for coupling to conduit of a drip irrigation line. Preferably, the inlet 140 has a diameter configured to frictionally engage the conduit. In alternative embodiments, the inlet 140 may be configured to directly receive conduit formed as a flexible feeder line.

The channel 116 may be described as having an upper channel 142 defined through the upper portion 120 and a lower channel 144 defined through the lower portion 122. The upper channel 142 is in fluid communication with the lower channel 144 so that the inlet 140, each of the plurality of outlets 132 and the terminal outlet 118 are all fluidically connected. An internal annular ledge 146 is formed in the channel 116 at the transition point between the upper channel 142 and the lower channel 144. The upper channel 142 has an internal diameter that is greater than the internal diameter of the lower channel 144. The change in the internal diameter of the channel 116 occurs at the ledge 146 where the upper channel 142 transitions into the lower channel 144.

In some preferred embodiments, the upper channel 142 provides an enclosed volume (also 142) for housing fertilizer for fertilizing plant roots. The fertilizer, in the form of a commercially available fertilizer stick, or plurality of such sticks, may be inserted into the enclosed volume 142 through the inlet at the proximal end 112. The enclosed volume 142 may include that portion of channel 116 that lies within the upper portion 120. A basket filter (not shown) may be installed within the enclosed volume 142 and be configured to rest on the ledge 146. The fertilizer may rest in the basket filter. In embodiments including fertilizer and basket filter, fluid communication between the upper channel 142 and the lower channel 144 is maintained. Preferably, the fertilizer inserted into the upper channel 142 is water soluble so that it will dissolve with the water introduced to the drivable drip stake 110. Further, a conventional fertilizer stick may be used in embodiments of the drivable drip stake 110 without a basket filter present in the upper channel 142. In such cases, the fertilizer stick is prevented from entering the lower channel 144 due to the smaller internal diameter of lower channel 144. The fertilizer stick will rest on the ledge 146 and begin to float as water is introduced into the upper channel 142, thereby opening a flow path into the lower channel 142. Without the basket filter present, the fertilizer stick may eventually fall into the lower channel 142 once it has sufficiently dissolved to a diameter less than the internal diameter of the lower channel 142.

As described above, each one of the aerated fins 130 includes a plurality of outlets 132. The outlets 132 are arranged along the longitudinal length of the aerated fins 130 and spaced apart equally from one another. In some preferred embodiments, the outlets 132 are arranged every 0.500 inches along the longitudinal length of the aerated fins 130. The diameter of each of the outlets 132 decreases in the direction from the proximal end 112 to the distal end 114. Said another way, the outlet 132 nearest the distal end 114, e.g., outlet labeled 131 in FIG. 2, has a diameter that is equal to or less than every upstream outlet.

In more elaborate and preferred embodiments, the outlets 132 are arranged into at least three distinct groups based on a common diameter thereof. Each group may include four outlets 132 having a common diameter, although more or less than four outlets may be included in each group within the scope of the present invention. The first group 148 is arranged closest to the upper portion 120, e.g., at the proximal end of the lower portion 122, and includes four outlets 132 having a first diameter, e.g., a diameter substantially equal to 0.050 inches. The third group 152 is arranged closest to the distal end 114 and includes four outlets 132 having a third diameter, e.g., a diameter substantially equal to 0.030 inches. The second group 150 is arranged between the first group 148 and the third group 152 and includes four outlets 132 having a second diameter, e.g., a diameter substantially equal to 0.040 inches. Thus, the arrangement of the outlet groups 148, 150, and 152 is such that the diameter of the outlets 132 decreases in the direction toward the distal end 114 of the drivable drip stake 110. Note, the specific diameters provided for the outlet groups 148, 150 and 152 are meant only as an example and in no way limit the present invention. Other outlet 132 diameters may be used within the scope of the present invention so long as the largest outlet diameter (or group of outlets having the largest common outlet diameter) is arranged closest to the upper portion 120 and the smallest outlet diameter (or group of outlets having the smallest common outlet diameter) is arranged closest to the distal end 114 of the lower portion 122.

The decrease in outlet 132 diameter toward the distal end 114 increases the water delivery efficiency of the drivable drip stake 110. The smaller diameter of the outlets 132 closest to the distal end 114 increases the upstream pressure within the channel 116 to ensure sufficient water is released from those outlets 132 located upstream, i.e., those outlets 132 in the first group 148 and the second group 150. The upstream pressure within the channel 116 may further be increased with the insertion of a plug, such as plug 137 shown exploded out of the distal end in FIG. 1, into the terminal outlet 118 at the distal end 114. In alternative embodiments, the distal end 114 may be molded closed so that there is no terminal outlet 118 formed thereat and thereby alleviating the need for the plug.

FIG. 5 is proximal end view of the drivable drip stake according to the present invention. In preferred embodiments, the planar surface 136 is preferably circular but in alternative embodiments the surface may take other geometric shapes, e.g., oval, square, triangular, etc. From this view, the channel 116 can be seen extending through the drivable drip stake 110. Further, the internal ledge 146 is visible from this proximal end view.

The drivable drip stake 110 according to the present invention is easier to deploy when compared to the prior art drip emitters. The driving means 136, 138 allow a user to install the drivable drip stake 110 with only a few strokes of a rubber mallet or other tool use to strike flat surfaces. The arrangement of the outlets 132 of largest diameter to the smallest diameter in the proximal to distal direction along the longitudinal length of the drivable drip stake 110 ensures more efficient watering is achieved.

The drivable drip stake 110 according to the present invention may be manufactured using conventional machining, injection molding, or additive manufacturing, such as three-dimensional printing techniques. Polymer materials, such as polypropylene, may be used for the injection molding. In some embodiments, the polymer material may have a glass content to strengthen the molded part. The inventors have found that injection molding using polypropylene with 30% glass filled content has produce a sufficiently durable drivable drip stake 110. Other rigid machinable or moldable materials may also be used.

In one exemplary embodiment, a drivable drip stake 110 according to the present invention has a total length from the proximal end 112 to the distal end 114 substantially equal to about 9.600 inches. The length of the upper portion 120 may be substantially equal to about 3.250 inches while the lower portion 122 has a length substantially equal to about 6.350 inches. The internal diameter of the upper channel 142 may be substantially equal to about 0.460 inches while the internal diameter of the lower channel 144 is substantially equal to about 0.196 inches. The outlets 132 are preferably longitudinally separated from one another by about 0.500 inches. The diameter of each outlet 132 depends on its location along the longitudinal length of the aerated fins 130, as described in more detail above.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A drivable drip emitter, comprising:
a stake having a lower portion, an upper portion, and an open-ended channel extending therethrough;
a pair of opposing solid fins extending from an outer surface of the lower portion;
a pair of opposing aerated fins extending from the outer surface of the lower portion, each of the aerated fins including a plurality of holes fluidically connecting the open-ended channel with a surrounding environment; and
a means for driving the stake formed at a proximal end of the upper portion.

2. The drip emitter of claim 1, wherein the plurality of holes are defined along a longitudinal length of the aerated fins.

3. The drip emitter of claim 2, wherein the plurality of holes are equally spaced apart along the longitudinal length of each of the aerated fins.

4. The drip emitter of claim 1, wherein a diameter of every upstream hole of the plurality of holes is greater than the diameter of any downstream hole of the plurality of holes.

5. The drip emitter of claim 1, wherein the plurality of holes are arranged into three distinct groupings based on hole diameter, wherein a first grouping is formed nearest a proximal end of the lower portion and has a first diameter, a second grouping is formed below the first grouping at an intermediate location along the longitudinal length of the lower portion and has a second diameter, and a third grouping is formed below the second grouping at a distal end of the lower portion and has a third diameter.

6. The drip emitter of claim 5, wherein the first diameter is greater than the second diameter and the second diameter is greater than the third diameter.

7. The drip emitter of claim 1, wherein the driving means comprises a planar surface formed at the proximal end of the upper portion, the planar surface defining an outer diameter that is greater than an outer diameter of the upper portion.

8. The drip emitter of claim 7, wherein the planar surface is perpendicular to a direction of flow through the open-ended channel.

9. The drip emitter of claim 7, further comprising a plurality of support trusses extending from a bottom side of the planar surface to an outer surface of the upper portion.

10. The drip emitter of claim 9, wherein each support truss integrally connects the bottom side to the outer surface.

11. The drip emitter of claim 9, wherein the plurality of trusses are symmetrically arranged around the outer surface of the upper portion.

12. The drip emitter of claim 1, wherein the open-ended channel comprises an upper channel having a first diameter and defined through the upper portion, and a lower channel having a second diameter and defined through the lower portion, wherein the upper channel and the lower channel are in fluid communication, and wherein the first diameter is greater than the second diameter.

13. The drip emitter of claim 12, wherein the upper channel is configured to receive a basket filter.

14. The drip emitter of claim 12, wherein the upper channel further comprises an internal ledge formed at a transition point where the upper channel transitions into the lower channel, wherein the internal ledge is configured as a seat for a basket filter.

15. The drip emitter of claim 14, wherein the upper portion is configured to enclose a fertilizer stick within the basket filter while maintaining fluid communication throughout the open-ended channel.

16. The drip emitter of claim 1, wherein an outer diameter defined by the solid fins and the aerated fins is substantially equal to an outer diameter of the upper portion.

17. The drip emitter of claim 16, wherein the outer surface of the lower portion defines an outer diameter that is less than the outer diameter of the upper portion.

18. The drip emitter of claim 1, further comprising a plug engaged to a distal end of the open-ended channel.

19. The drip emitter of claim 1, wherein a distal end of each of the solid fins and the aerated fins tapers into the outer surface of the lower portion.

20. The drip emitter of claim 19, wherein each fin extends substantially an entire longitudinal length of the lower portion.
